(19) United States
(12) Patent Application Publication
(10) Pub. No.: US 2023/0402780 A1
(43) Pub. Date: Dec. 14, 2023

(54) CONNECTOR AND MOTOR HAVING THE CONNECTOR

(71) Applicants: GUANGDONG WELLING MOTOR MANUFACTURING CO., LTD.; WELLING (WUHU) MOTOR MANUFACTURING CO., LTD., Wuhu (CN)

(72) Inventors: Chengtong LIU, Foshan (CN); Jianwu TANG, Foshan (CN)

(73) Assignees: GUANGDONG WELLING MOTOR MANUFACTURING CO., LTD., Foshan (CN); WELLING (WUHU) MOTOR MANUFACTURING CO., LTD., Wuhu (CN)

(21) Appl. No.: 18/239,203

(22) Filed: Aug. 29, 2023

Related U.S. Application Data
(63) Continuation of application No. PCT/CN2021/123024, filed on Oct. 11, 2021.

(30) Foreign Application Priority Data
Mar. 3, 2021 (CN) 202110236227.6
Mar. 3, 2021 (CN) 202120465896.6

(51) Int. Cl. H01R 13/35; H02K 5/22; H02K 11/33

(52) U.S. Cl. CPC H01R 13/35; H02K 5/225; H02K 11/33; H02K 2211/03; H01R 2201/10

(57) ABSTRACT

Disclosed is a connector. The connector includes a body, a wiring terminal, and a wire fixing component. The body has a terminal hole. The terminal hole has a first end and a second end. A wiring terminal is fitted in the terminal hole. The wire fixing component is detachably connected to the body and is located at the first end of the terminal hole. The wire fixing component has at least one wire passing groove. The at least one wire passing groove is aligned with the terminal hole along an axial direction of the terminal hole, and the wiring terminal abuts against the wire fixing component to prevent the wiring terminal from entering the at least one wire passing groove.

### CROSS-REFERENCE TO RELATED APPLICATIONS

This application is a continuation application of International Application No. PCT/CN2021/123024, filed on Oct. 11, 2021, which claims priority to and benefits of Chinese Patent Application No. 202110236227.6, filed on Mar. 3, 2021, and Chinese Patent Application No. 202120465896.6, filed on Mar. 3, 2021, the entire contents of each of which are incorporated herein by reference for all purposes. No new matter has been introduced.

### FIELD

The present disclosure relates to the field of motor technologies, and more particularly, to a connector and a motor having the connector.

### BACKGROUND

Currently, when internal electrical components of an air conditioner are connected, a wiring terminal is prone to disengagement, resulting in loose wiring. Therefore, it is possible to lead to unstable or non-starting motor operation, and adversely affect normal operation of the air conditioner.

### SUMMARY

The present disclosure is made at least based on the inventors' findings and understanding of the following facts and problems.

In the related art, after a wiring terminal used for a connection of a conducting wire of a motor in an appliance (such as, an air conditioner) is connected, fixing effectiveness can be poor, which causes the motor to be easily loosened during operation. Thus, the motor may not be started or unstable during operation, Therefore, operation of the air conditioner or user experience is affected.

To this end, an embodiment of the present disclosure provides a connector with an effectively anti-loosening effect.

According to at least one embodiment of the present disclosure, provided is a connector. The connector includes a body, a wiring terminal, and a wire fixing component. The body has a terminal hole. The terminal hole has a first end and a second end. The wiring terminal is fitted in the terminal hole. The wire fixing component is detachably connected to the body and is located at the first end of the terminal hole. The wire fixing component has at least one wire passing groove. The at least one wire passing groove is aligned with the terminal hole along an axial direction of the terminal hole, and the wiring terminal abuts against the wire fixing component to prevent the wiring terminal from entering the at least one wire passing groove.

Based on the connector according to the at least one embodiment of the present disclosure, the wiring terminal is fixed by arranging the wire fixing component, which can effectively prevent the wiring terminal from loosening, thereby having the characteristics of a compact structure, effective anti-looseness, and safety and reliability.

In some embodiments, the wiring terminal has a connection end and a wiring end. The wiring end is provided with an elastic claw. A stop part is disposed in the terminal hole, and the elastic claw abuts against the stop part to prevent the wiring terminal from moving towards the first end of the terminal hole.

In some embodiments, each of the at least one wire passing groove is a groove closed in a circumferential direction or a groove opened in the circumferential direction.

In some embodiments, a cross section of a wiring end is greater than a cross section of the at least one wire passing groove.

In some embodiments, the terminal hole includes a first hole section and a second hole section. The connection end is located in the second hole section. The wiring end is located in the first hole section. The second hole section has a cross sectional area greater than a cross sectional area of the first hole section to form a step at a connection between the first hole section and the second hole section, and the stop part is formed by the step.

In some embodiments, the elastic claw and the wiring terminal are integrally formed.

In some embodiments, the wire fixing component is mounted to the connector through a buckle structure.

In some embodiments, the wire fixing component includes a wire fixing body and a hook integrally formed on the wire fixing body. The hook is engaged with a clamping portion on the body.

In some embodiments, the wire fixing body is substantially U-shaped; the at least one wire passing groove is formed on at least one side surface of a bottom part of the wire fixing body; and the hook includes a first hook formed at a free end of a first side wall of the wire fixing body, a second hook formed at a free end of a second side wall of the wire fixing body, and a third hook formed on the at least one side surface of the bottom part of the wire fixing body.

In some embodiments, the at least one wire passing groove is formed on two side surfaces of the bottom part of the wire fixing body. At least one wire passing groove formed on each of the two side surfaces includes a plurality of wire passing grooves arranged at intervals in a length direction of the bottom part.

In some embodiments, each of the at least one wire passing groove is a U-shaped groove.

In some embodiments, a wiring end of the wiring terminal is provided with a terminal tip abutting with the wire fixing component.

In some embodiments, the at least one wire passing groove includes a plurality of wire passing grooves arranged in at least one row. The plurality of wire passing grooves in one row are arranged at intervals in a predetermined direction.

According to another embodiment of the present disclosure, a motor is further provided. The motor includes the connector as described above. The motor is convenient to install and stable in performance.

In other embodiments, the motor further includes a circuit board and a wire connector. A jack is formed on the circuit board, and the wire connector has a pin engaged into the jack. A conducting wire connected to the wiring end of the wiring terminal is connected to the pin.

### BRIEF DESCRIPTION OF THE DRAWINGS

FIG. 1 is a schematic structural diagram of a connector according to an embodiment of the present disclosure.

FIG. 2 is a cross-sectional view of the connector illustrated in FIG. 1.

FIG. 3 is another cross-sectional view of the connector illustrated in FIG. 1.

FIG. 4 is a schematic structural diagram of a wiring terminal illustrated in the connector of FIG. 1.

FIG. 5 is a schematic diagram of a connection wire of the wiring terminal illustrated in FIG. 4.

FIG. 6 is a schematic structural diagram of a wire fixing component illustrated in the connector of FIG. 1.

FIG. 7 is a schematic diagram of a motor according to an embodiment of the present disclosure.

### REFERENCE NUMERALS

connector 100, pin 200, body 1, terminal hole 11, first end 111, second end 112, first hole section 113, second hole section 114, stop part 115, clamping portion 116, wiring terminal 2, connection end 21, wiring end 22, terminal tip 221, elastic claw 23, wire fixing component 3, wire passing groove 31, wire fixing body 32, first side wall 321, second side wall 322, bottom part 323, hook 33, first hook 331, second hook 332, third hook 333, circuit board 300, wire connector 400, jack 500, conducting wire 600.

### DETAILED DESCRIPTION

The embodiments of the present disclosure will be described in detail below with reference to examples thereof as illustrated in the accompanying drawings. The embodiments described below with reference to the accompanying drawings are illustrative only, and are intended to explain, rather than limiting the present disclosure. It is to be understood that, terms such as “center”, “longitudinal”, “lateral”, “length”, “width”, “thickness”, “over”, “below”, “front”, “back”, “left”, “right”, “vertical”, “horizontal”, “top”, “bottom”, “in”, “out”, “clockwise”, “anti-clockwise”, “axial”, “radial” and “circumference” refer to the directions and location relations which are the directions and location relations shown in the drawings, and for describing the present disclosure and for describing in simple, and which are not intended to indicate or imply that the device or the elements are disposed to locate at the exemplary directions or are structured and performed in the exemplary directions, which could not to be understood to the limitation of the present disclosure.

A connector according to embodiments of the present disclosure is described below with reference to FIGS. 1 to 6.

The connector according to the embodiments of the present disclosure includes a body 1, a wiring terminal 2, and a wire fixing component 3.

The body 1 has a terminal hole 11. The terminal hole 11 has a first end 111 and a second end 112. The wiring terminal 2 is fitted in the terminal hole 11.

The wire fixing component 3 is detachably connected to the body 1 and located at the first end 111 of the terminal hole 11. The wire fixing component 3 has at least one wire passing groove 31. The at least one wire passing groove 31 is aligned with the terminal hole 11 along an axial direction of the terminal hole 11, and the wiring terminal 2 abuts against the wire fixing component 3 to prevent the wiring terminal 2 from entering the at least one wire passing groove 31. Therefore, the wiring terminal 2 is prevented from moving towards the first end 111 of the terminal hole 11 and is prevented from being disengaged from the terminal hole 11.

As illustrated in FIG. 1 to FIG. 3, the body 1 is generally plate-shaped and has a protrusion on a front side of the body 1. A plurality of terminal holes 11 are disposed at a lower side of the protrusion and penetrates the protrusion along a forward-backward direction. The terminal hole 11 has the first end 111 as a front end and the second end 112 as a rear end. The plurality of terminal holes 11 are arranged in a plurality of rows. The plurality of terminal holes 11 in the plurality of rows are arranged at intervals along an upward-downward direction, and the plurality of terminal holes 11 in each row are arranged at intervals along a left-right direction.

The wire fixing component 3 is detachably disposed on the body 1 and is located at the front end of the terminal hole 11. The wire fixing component 3 is further provided with a plurality of wire passing grooves 31. The plurality of wire passing grooves 31 are arranged in a plurality of rows. The plurality of wire passing grooves 31 in the plurality of rows are oppositely arranged in the upward-downward direction, and the plurality of wire passing grooves 31 in each row are arranged at intervals in the left-right direction. The plurality of wire passing grooves 31 are in one-to-one correspondence with the plurality of terminal holes 11. The wiring terminal 2 abuts against a rear side surface of the wire fixing component 3. Therefore, the wiring terminal 2 cannot be disengaged from the terminal hole 11.

Based on the connector according to the embodiments of the present disclosure, the wiring terminal 2 is fixed by arranging the wire fixing component 3. Therefore, disengagement of the wiring terminal 2 may be effectively avoid, thereby having the characteristics of the compact structure, effective anti-disengagement, and safety and reliability.

In some embodiments, the wiring terminal 2 is provided with an elastic claw 23. A stop part 115 is disposed in the terminal hole 11, and the elastic claw 23 abuts against the stop part 115 to prevent the wiring terminal 2 from moving towards the first end 111. The wiring terminal 2 has a connection end 21 and a wiring end 22. For example, the connection end 21 may be connected to a wiring terminal of another connection components, and the wiring end 22 is configured to be connected to a conducting wire 600.

In FIG. 1 to FIG. 3, the elastic claw 23 is disposed adjacent to the connection end 21. The wiring terminal 2 is located in the terminal hole 11. The stop part 115 is disposed on an inner wall of the terminal hole 11. A free end of the elastic claw 23 may abut against the stop part 115. Therefore, the elastic claw 23 is prevented from moving forwards from the back.

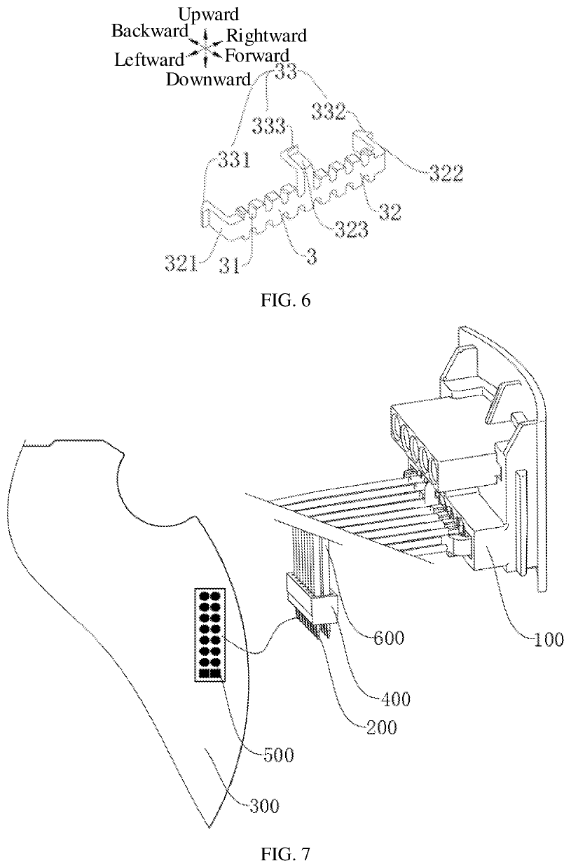

In some embodiments, each of the at least one wire passing groove 31 is a groove closed in a circumferential direction or a groove opened in the circumferential direction. As illustrated in FIG. 6, the wire passing groove 31 penetrates the wire fixing component 3 along a forward-backward direction of the wire fixing component 3. The wire passing groove 31 is an open groove opened at a side surface of the wire passing groove 31. The conducting wire 600 passes through the wire passing groove 31.

In some embodiments, a cross section of a wiring end 22 is greater than a cross section of the at least one wire passing groove 31. As illustrated in FIG. 1 to FIG. 3, the cross section of the wire passing groove 31 is smaller than the cross section of the wiring end 22, thereby preventing the wiring end 22 from entering the wire passing groove 31. Therefore, the fixing of the wiring terminal 2 is completed and the wiring terminal 2 is effectively prevented from disengaging from the terminal hole 11.

In some embodiments, the terminal hole 11 includes a first hole section 113 and a second hole section 114. The connection end 21 is located in the second hole section 114. The wiring end 22 is located in the first hole section 113. The second hole section 114 has a cross sectional area greater than a cross sectional area of the first hole section 113 to form a step at the connection between the first hole section 113 and the second hole section 114, and the stop part 115 is formed by the step.

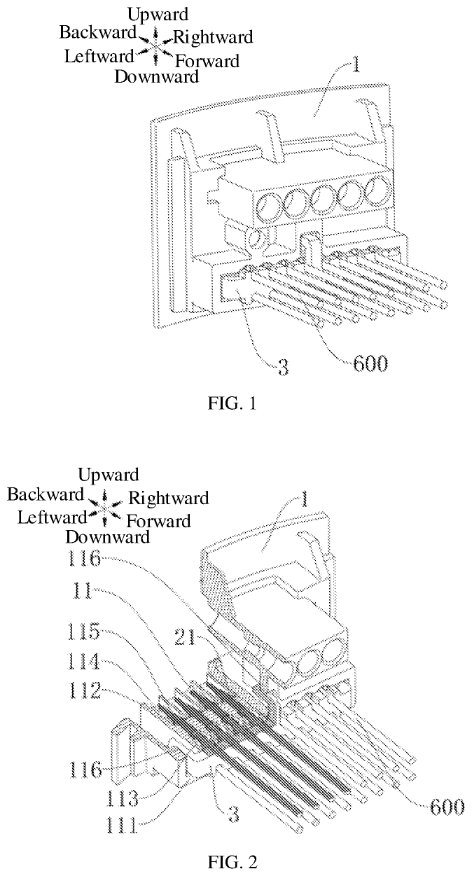

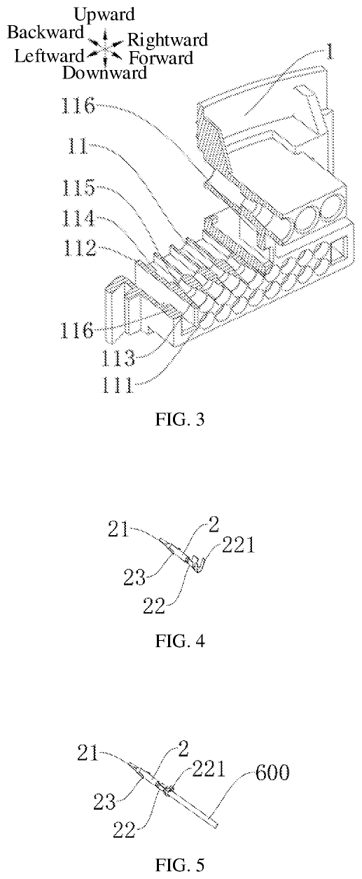

As illustrated in FIG. 2 and FIG. 3, the first hole section 113 and the second hole section 114 are connected to each other in the forward-backward direction and are in communication with each other. The cross sectional area of the second hole section 114 is constant in the forward-backward direction and is greater than the cross sectional area of the first hole section 113. A stepped stop part 115 is formed at the connection between the first hole section 113 and the second hole section 114. The connection end 21 of the wiring terminal 2 enters the second hole section 114 from the first hole section 113. The free end of the elastic claw 23 contracts in the first hole section 113, then expands after entering the second hole section 114, and abuts against the stop part 115 to prevent the wiring terminal 2 from disengaging from the terminal hole 11.

In some embodiments, the elastic claw 23 and the wiring terminal 2 are integrally formed. As illustrated in FIG. 3, the elastic claw 23 and the wiring terminal 2 are of a one-piece structure. It can be understood that the elastic claw 23 and the wiring terminal 2 may be one-time formed through plastic injection-molding. Based on the connector according to the embodiments of the present disclosure, when the elastic claw 23 and the wiring terminal 2 are of the one-piece structure, the wiring terminal 2 is structurally simple and convenient to install and has satisfactory reliability.

In some embodiments, the wire fixing component 3 is mounted to the connector 100 through a buckle structure. As illustrated in FIG. 1 and FIG. 2, the wire fixing component 3 is detachably mounted on the body 1 through the buckle structure, and has the characteristics of simple operation and easy installation. It can be understood that a detachable connection manner of the wire fixing component 3 and the connector 100 is not limited thereto. For example, the wire fixing component 3 may also be connected to the connector 100 through threads.

In some embodiments, the wire fixing component 3 includes a wire fixing body 32 and a hook 33 integrally formed on the wire fixing body 32. The hook 33 is engaged with a clamping portion 116 on the body 1. As illustrated in FIG. 6, the wire fixing body 32 is provided with a hook 33. The hook 33 and the wire fixing body 32 are integrally formed. The buckle structure is formed by the hook 33 and the clamping portion 116 on the body 1. The wire fixing body 32 is connected to the body 1. Thus, the likelihood of misalignment or omission during assembly of the wire fixing component 3 can be reduced. In addition, it is possible to streamline the operation steps and improve production efficiency.

In some embodiments, the wire fixing body 32 is substantially U-shaped. The at least one wire passing groove 31 is formed on at least one side surface of a bottom part 323. The hook 33 includes a first hook 331 formed at a free end of a first side wall 321 (a left side wall of the wire fixing body illustrated in FIG. 6), a second hook 332 formed at a free end of a second side wall 322 (a right side wall of the wire fixing body illustrated in FIG. 6) of the wire fixing body 32, and a third hook 333 formed on the at least one side surface of the bottom part 323.

As illustrated in FIG. 6, the first hook 331 is formed at the left side wall of the wire fixing body 32. The second hook 332 is formed at the right side wall of the wire fixing body 32. The third hook 333 is formed on the bottom part 323. The first hook 331, the second side wall 322, and the third hook 333 are engaged with a plurality of clamping portions 116 on the body 1 in a one-to-one correspondence, respectively. In this case, the wire fixing body 32 is firmly fixed on the body 1. The wire passing groove 31 is formed on an upper side surface or a lower side surface of the bottom part 323. The wiring end 22 of the wiring terminal is connected to the conducting wire 600. The conducting wire 600 passes through the wire passing groove 31, and the wire passing groove 31 may fix the conducting wires 600 one by one.

In some embodiments, the at least one wire passing groove 31 is formed on two side surfaces of the bottom part 323. At least one wire passing groove 31 formed on each of the two side surfaces includes a plurality of wire passing grooves 31 arranged at intervals in a length direction of the bottom part 323.

As illustrated in FIG. 6, the plurality of wire passing grooves 31 are dispose both on the upper side surface and the lower side surface of the bottom part 323. The plurality of wire passing grooves 31 located on the upper side surface of the bottom part 323 are arranged at intervals in the left-right direction. The plurality of wire passing grooves 31 located on the lower side surface of the bottom part 323 is arranged at intervals in the left-right direction. Moreover, the plurality of wire passing grooves 31 located on the upper side surface of the bottom part 323 and the plurality of wire passing grooves 31 located on the lower side surface of the bottom part 323 are arranged at equal intervals.

Based on the connector according to the embodiments of the present disclosure, the plurality of wire passing grooves 31 are provided, allowing for the conducting wires 600 to be arranged in order. This arrangement ensures that the conducting wires are organized in a tidy manner. Meanwhile, the risk of short circuits caused by entanglement between different lines may be avoided.

In some embodiments, each of the at least one wire passing groove 31 is a U-shaped groove.

As illustrated in FIG. 6, the wire passing groove 31 located on the upper side surface of the bottom part 323 is a U-shaped groove with an upward opening. The wire passing groove 31 located on the lower side surface of the bottom part 323 is a U-shaped groove with a downward opening. A bottom surface of the wire passing groove 31 is an arc-shaped surface. When the conducting wire 600 extends into the wire passing groove 31, the bottom surface of the wire passing groove 31 is attached to an outer peripheral surface of the conducting wire 600.

Based on the connector according to the embodiments of the present disclosure, the bottom surface of the wire passing groove 31 is configured as the arc-shaped surface, which can increase a contact area between the conducting wire 600 and the wire passing groove 31. Therefore, the conducting wire 600 may be fixed more conveniently.

In some embodiments, the at least one wire passing groove 31 includes a plurality of wire passing grooves 31 arranged in at least one row. The plurality of wire passing grooves 31 in one row are arranged at intervals in a predetermined direction (the left-right direction illustrated in FIG. 6). As illustrated in FIG. 6, the plurality of wire passing grooves 31 is arranged in two rows. The plurality of wire passing grooves 31 in two rows are arranged at intervals in the upward-downward direction. The plurality of wire passing grooves 31 in each row are arranged at intervals in the left-right direction. With this arrangement, the conducting wires 600 are arranged neatly, ensuring that the conducting wires 600 are not in contact with each other. As a result, dangers, such as short circuits, can be avoided.

In some embodiments, a wiring end 22 (the front end of the wiring terminal 2 illustrated in FIG. 6) is provided with a terminal tip 221 abutting with the wire fixing component 3.

As illustrated in FIG. 4 and FIG. 5, after the wire fixing component 3 is connected to the body 1, the terminal tip 221 abuts against the wire fixing component 3. The terminal tip 221 is disposed at the wiring end 22 and includes two support plates in a U-shape opened upwards. The two support plates have bottoms connected with each other and are arranged at intervals in the forward-backward direction. The U-shaped support plate is provided with two side walls extending upwards. After the conducting wires are connected to the wiring terminals, the side walls are bent to fix the conducting wires 600. Meanwhile, the frontmost U-shaped support plate abuts against the wire fixing component 3 to fix the wiring terminal 2 through engaging with the wire fixing component 3.

A motor according to some embodiments of the present disclosure will be described referring to FIG. 7.

As illustrated in FIG. 7, the motor according to some embodiments of the present disclosure includes the connector 100 according to the above embodiments.

With the motor according to these embodiments of the present disclosure, the motor is simple to install, which may enhance the production efficiency.

In some embodiments, the motor further includes a circuit board 300 and a wire connector 400. A jack 500 is formed on the circuit board 300. The wire connector 400 has a pin 200 engaged into the jack 500. A conducting wire 600 connected to the wiring end 22 of the wiring terminal 2 is connected to the pin 200.

As illustrated in FIG. 7, a plurality of jacks 500 can be formed on the circuit board 300. The wire connector 400 has a plurality of pins 200 formed thereon. The plurality of pins 200 are engaged into the plurality of jacks 500 in a one-to-one correspondence. The plurality of pins 200 are connected to the wiring end 22 through the conducting wires 600.

With the motor according to the embodiments of the present disclosure, the conducting wire has a reliable connection, and the wiring terminal is not easy to loosen.

In the description of the present disclosure, it is to be understood that, terms such as “center”, “longitudinal”, “lateral”, “length”, “width”, “thickness”, “over”, “below”, “front”, “back”, “left”, “right”, “vertical”, “horizontal”, “top”, “bottom”, “in”, “out”, “clockwise”, “anti-clockwise”, “axial”, “radial” and “circumference” refer to the directions and location relations which are the directions and location relations shown in the drawings, and for describing the present disclosure and for describing in simple, and which are not intended to indicate or imply that the device or the elements are disposed to locate at the exemplary directions or are structured and performed in the exemplary directions, which could not to be understood to the limitation of the present disclosure.

In addition, terms such as “first” and “second” are used herein for purposes of description and are not intended to indicate or imply relative importance or significance. Furthermore, the feature defined with “first” and “second” may comprise one or more this feature distinctly or implicitly. In the description of the present disclosure, “a plurality of” means two or more than two, unless specified otherwise.

In the present disclosure, unless specified or limited otherwise, the terms “mounted,” “connected,” “coupled” and “fixed” are understood broadly, such as fixed, detachable mountings, connections and couplings or integrated, and can be mechanical or electrical mountings, connections and couplings, and also can be direct and via media indirect mountings, connections, and couplings, and further can be inner mountings, connections and couplings of two components or interaction relations between two components, which can be understood by those skilled in the art according to the detail embodiment of the present disclosure.

In the present disclosure, unless expressly stipulated and defined otherwise, the first feature “on” or “under” the second feature may mean that the first feature is in direct contact with the second feature, or the first and second features are in indirect contact through an intermediate. Moreover, the first feature “above” the second feature may mean that the first feature is directly above or obliquely above the second feature, or simply mean that the level of the first feature is higher than that of the second feature. The first feature “below” the second feature may mean that the first feature is directly below or obliquely below the second feature, or simply mean that the level of the first feature is smaller than that of the second feature.

In the description of this specification, descriptions with reference to the terms “an embodiment”, “some embodiments”, “examples”, “exemplary examples”, or “some examples”, etc. mean that exemplary features, structure, materials or characteristics described in conjunction with the embodiment or example are included in at least one embodiment or example of the present disclosure. In this specification, the schematic representations of the above terms do not necessarily refer to the same embodiment or example. Moreover, the described exemplary features, structures, materials or characteristics may be combined in any one or more embodiments or examples in a suitable manner. Moreover, the described exemplary features, structures, materials, or characteristics may be combined in any one or more embodiments or examples in a suitable manner. In addition, those skilled in the art can combine the different embodiments or examples and the features of the different embodiments or examples described in this specification without contradicting each other.

Although the embodiments of the present disclosure have been shown and described above, it can be understood that the above-mentioned embodiments are exemplary and should not be construed as limiting the present disclosure. Those of ordinary skill in the art can make changes, modifications, substitutions and modifications to the above-mentioned embodiments within the scope of the present disclosure.

What is claimed is:

1. A connector comprising:
a body having a terminal hole, the terminal hole having a first end and a second end;
a wiring terminal fitted in the terminal hole; and
a wire fixing component detachably connected to the body and located at the first end of the terminal hole, the wire fixing component having at least one wire passing groove, the at least one wire passing groove being aligned with the terminal hole along an axial direction of the terminal hole, and the wiring terminal abutting against the wire fixing component to prevent the wiring terminal from entering the at least one wire passing groove.

2. The connector according to claim 1, wherein the wiring terminal has a connection end and a wiring end, the wiring end being provided with an elastic claw, a stop part being disposed in the terminal hole, and the elastic claw abutting against the stop part to prevent the wiring terminal from moving towards the first end of the terminal hole.

3. The connector according to claim 1, wherein each of the at least one wire passing groove comprises a groove closed in a circumferential direction or a groove opened in the circumferential direction.

4. The connector according to claim 1, wherein a cross section of the wiring end is greater than a cross section of the at least one wire passing groove.

5. The connector according to claim 2, wherein the terminal hole comprises a first hole section and a second hole section, the connection end being located in the second hole section, the wiring end being located in the first hole section, the second hole section having a cross sectional area greater than a cross sectional area of the first hole section to form a step at a connection between the first hole section and the second hole section, and the stop part being formed by the step.

6. The connector according to claim 2, wherein the elastic claw and the wiring terminal are integrally formed.

7. The connector according to claim 1, wherein the wire fixing component is mounted to the connector through a buckle structure.

8. The connector according to claim 7, wherein the wire fixing component comprises a wire fixing body and a hook integrally formed on the wire fixing body, the hook being engaged with a clamping portion on the body.

9. The connector according to claim 8, wherein the buckle structure is formed by the hook and the clamping portion.

10. The connector according to claim 9, wherein:
the wire fixing body is substantially U-shaped; and
the at least one wire passing groove is formed on at least one side surface of a bottom part of the wire fixing body.

11. The connector according to claim 10, wherein the hook comprises a first hook formed at a free end of a first side wall of the wire fixing body, a second hook formed at a free end of a second side wall of the wire fixing body, and a third hook formed on the at least one side surface of the bottom part of the wire fixing body.

12. The connector according to claim 11, wherein the at least one wire passing groove is formed on two side surfaces of the bottom part of the wire fixing body, at least one wire passing groove formed on each of the two side surfaces comprising a plurality of wire passing grooves arranged at intervals in a length direction of the bottom part.

13. The connector according to claim 11, wherein each of the at least one wire passing groove comprises is a U-shaped groove.

14. The connector according to claim 1, wherein a wiring end of the wiring terminal is provided with a terminal tip abutting with the wire fixing component.

15. The connector according to claim 1, wherein the at least one wire passing groove comprises a plurality of wire passing grooves arranged in at least one row, the plurality of wire passing grooves in one row being arranged at intervals in a predetermined direction.

16. A motor comprising the connector according to claim 1.

17. The motor according to claim 16, further comprising:
a circuit board, a jack being formed on the circuit board; and
a wire connector having a pin engaged into the jack, a conducting wire connected to the wiring end of the wiring terminal being connected to the pin.
